(19) United States
(12) Patent Application Publication
(10) Pub. No.: US 2004/0262050 A1
(43) Pub. Date: Dec. 30, 2004

(54) Seat weighing system

(75) Inventor: Tomotoshi Senoo, Hikone (JP)

Correspondence Address: FOLEY AND LARDNER, SUITE 500, 3000 K STREET NW, WASHINGTON, DC, 20007, US

(73) Assignee: TAKATA CORPORATION

(21) Appl. No.: 10/838,200

(22) Filed: May 5, 2004

(30) Foreign Application Priority Data
Jun. 27, 2003 (JP) 2003-184967
Feb. 5, 2004 (JP) 2004-028889

(51) Int. Cl. G01G 19/08; G01G 19/52

(52) U.S. Cl. 177/144

(57) ABSTRACT

A seat weighing system which can easily be assembled and in which the entire system including a base can be made low profile. A seat weighing system includes a base. The base is constructed of two load transmission bases and a load sensor base, which are separated from each other. The height of the load sensor base is set smaller than those of the load transmission bases. The load transmission bases include therein an arm for transmitting a seat weight to a load sensor; the load sensor base includes therein the load sensor. The separating structure of the base facilitates the assembly. Setting the load sensor base lower than the load transmission bases allows the entire system including the base to be made low profile.

### BACKGROUND OF THE INVENTION

The present invention relates to a seat weighing system mounted to a vehicle seat for weighing a seat including an occupant seated therein.

As systems for ensuring the safe of occupants in vehicles, a seatbelt system and an airbag system are provided. An attempt to control the operation of the safety systems depending on the weight and position of the occupants has recently been made to increase the performance of the seat belts and the airbags. For example, the amount of airbag deployment gas, deployment speed, and pretension of the seat belts are controlled depending on the weight and position of the occupants. To this end, it is necessary to know the weight of seated occupants and the center of gravity of the occupants on the seats.

In response to the requirements, a seat weighing system is proposed which is capable of seat weight measurement as inexpensive and precise as possible, as shown in, for example, Japanese Unexamined Patent Application No. 2001-041813 (hereby incorporated by reference herein in its entirety).

FIGS. 5(A) and 5(B) partially show the front of a seat weighing system disclosed in the above mentioned Application No. 2001-041813, in which FIG. 5(A) is an exploded perspective view thereof and FIG. 5(B) is a front sectional view of a pin bracket. FIGS. 6(A)-6(D) partially show the front of the seat weighing system of FIG. 5, in which FIG. 6(A) is a plan view thereof, FIG. 6(B) is a sectional view taken along the length, FIG. 6(C) is a sectional view taken along line C-C of FIG. 6(B), and FIG. 6(D) is a sectional view taken along line D-D of FIG. 6(B).

Referring to FIGS. 5(A) and 5(B) and FIGS. 6(A) and 6(B), the known seat weighing system 9 is constructed with a thin long base 21 as the base. The base 21 extends longitudinally when mounted to a vehicle body. Referring to FIGS. 6(C) and 6(D), the base 21 is a steel press plate constructed of a bottom plate 21c and side plates 21a and 21a′ rising from the left and right ends of the bottom plate 21c, bent at an angle of 90 degrees to form a top-open U shape in cross section.

The base side plates 21a and 21a′ each have pin holes 21e and 21g at the front and the rear, respectively. The pin holes 21e and 21g are opened in each of the left and right side plates 21a and 21a′ such that they face each other. The holes 21e adjacent to the end are opened in the positions adjacent to the center from the front and rear end of the base 21 by approximately ⅛ of the entire length of the base 21. Each hole 21e is slotted vertically, as shown in FIG. 5(A). In the slotted hole 21e, the end of a bracket pin 27 is inserted. The bracket pin 27 has retainers 33 mounted to opposite ends thereof. The retainer 33 prevents the bracket pin 27 from coming off from the slotted hole 21e.

There is, however, clearance around the bracket pin 27 and the slotted hole 21e, so that the bracket pin 27 is not normally in contact with the inner periphery of the slotted hole 21e. However, when an excess load is applied to the seat weighing system 9 (specifically, the pin bracket 25), the bracket pin 27 moves downward to come into contact with the lower periphery of the slotted hole 21e, so that the excess load is not transmitted to a load sensor 50 on a sensor plate (spring member) 51. Briefly, the bracket pin 27 and the slotted hole 21e construct part of a mechanism that sets the upper limit of the load applied to the sensor plate 51. The main role of the bracket pin 27 is to transmit the seat weight applied to the pin bracket 25 to an arm 23 serving as a load transmitting member.

The pin holes 21g are provided in the positions slightly adjacent to the center from the slotted holes 21e (adjacent to the center by approximately 1/10 of the entire length of the base 21). A base pin 31 is passed through pin holes 21g. The base pin 31 is placed between the side plates 21a and 21a′. A retainer 33 is mounted to each of opposite ends of the base pin 31, with which the base pin 31 is fixed to the base 21. The base pin 31 is a rotation center shaft of the arm 23.

The arm 23 is made of an elastic material and is disposed inside the base 21. The arm 23 is forked into right and left parts (crotch portion 23h) adjacent to the center and is rectangular adjacent to the front and rear ends, in plan view. The left and right ends of the half of the arm 23 adjacent to the front and rear ends each have a side plate 23a bent upward at 90 degrees. The crotch portion 23h is a simple flat plate. The side plate 23a is formed along the inside of the side plate 21 a of the base 21. There is clearance between the side plates 23a and 21a.

The Z-arm side plate 23a also has two pin holes 23c and 23e. The pin holes 23c adjacent to the front and rear ends have the bracket pin 27 passed therethrough. The pin holes 23c and the bracket pin 27 do not slide to each other. The base pin 31 passes through the pin holes 23e adjacent to the center. The base pin 31 is the rotation center of the arm 23. The pin hole 23e and the base pin 31 slide to each other by an amount corresponding to the rotation of the arm 23. Between the base side plate 21a around the base pin 31 and the Z-arm side plate 23a, a perforated spacer 35 shaped like a circular disk is fitted.

The crotch portion 23h of the arm 23 is approximately half of the entire length of the arm 23. The crotch portion 23h is forked into the left and right parts toward the center of the length and is decreased in width adjacent to the center. Operating sections 23j at the ends of the crotch portion 23h of the arm 23 are held between respective vanes 41a and 42a of upper and lower half arms 41 and 42. The lower surface of the body of the upper half arm 41 and the upper surface of the body of the lower half arm 42 are flat and are fixed in close contact with the surface of the sensor plate 51 with a screw 43.

When a load is applied to the pin bracket 25, the load is applied to the arm 23 and so the arm 23 rotates slightly (approximately five degrees at the maximum) to transmit the load from the operating sections 23j through the upper and lower half arms 41 and 42 to the sensor plate 51. Referring to FIG. 7, the load sensor 50 is formed on the sensor plate 51. Of four strain resistors constructing the load sensor 50, two strain resistors 54a and 54b are arranged on the side of drawing strain and the other two strain resistors 54c and 54d are arranged on the side of compressing strain. The four strain resistors 54a, 54b, 54c, and 54d are arranged in order in the longitudinal direction of the sensor plate 51 along the line passing through the center of the sensor.

The four strain resistors 54a, 54b, 54c, and 54d are connected together by wiring to form a bridge circuit. Referring to FIG. 6(C), the pin bracket 25 is of approximately bottom-open U-shape in cross section and is not so long longitudinally, approximately 1/20 of the base 21. The upper surface 25a of the pin bracket 25 is flat, on which a seat rail 7 is placed. They are firmly connected with each other with a bolt and the like. The sensor plate 51 is fixed to a column 63 rising in the center of the base bottom plate 21c with a nut 68 and a fastener 69 such as a screw and a bolt.

Opposite side plates 25b of the pin bracket 25 hang down from the left and right of the pin bracket 25 and the lower ends are bent inwardly. The side plates 25b are arranged with play inside the Z-arm side plates 23a and 23a′. The side plates 25b each have a pin hole 25c. The pin hole 25c has the bracket pin 27 therethrough. The size of the pin hole 25c is larger than the diameter of the bracket pin 27. The clearance therebetween absorbs size error of the seat and the vehicle body and unexpected deformation.

A leaf spring 29 is placed between the opposite side plates 25b of the pin bracket 25 and the opposite Z-arm side plates 23a. The leaf spring 29 has a perforated spring washer, and is fitted on the outside of the bracket pin 27 with clearance therebetween. The leaf spring 29 constructs a centering mechanism for biasing the pin bracket 25 toward the center. The centering mechanism forces the pin bracket 25 to be positioned in the vicinity of the center in a slidable range.

In the seat weighing system 9, the seat rail 7, the pin bracket 25, the arm 23, the base 21, a seat bracket 11 and so on construct a joint mechanism for the seat and the vehicle body.

With the seat weighing system disclosed in the above mentioned Japanese Unexamined Patent Application No. 2001-041813, since the arm 23 for transmitting a load to the load sensor 50 and the base 21 for supporting the load sensor 50 are constructed of a long U-shaped member in cross section, it is troublesome to combine the arm 23 and the load sensor 50 with the base 21. Thus, the assembly of the seat weighing system has been relatively troublesome.

Since the fastener 69 for retaining the sensor plate 51 to the base 21 protrudes vertically (along the height) from the bottom of the base 21, it has been an impediment in achieving a thinner seat weighing system 9 including the base 21.

### SUMMARY OF THE INVENTION

The present invention has been made in view of the above problems. Accordingly, an object of the invention is to provide a seat weighing system which can easily be assembled and in which the entire system including the base can be made low profile.

According to an embodiment of the invention, a seat weighing system is provided which includes: a load sensor for weighing a seat including an occupant seated in a vehicle seat; a load transmitting member for transmitting the seat weight to the load sensor; and a base for supporting the load sensor and the load transmitting member, wherein the base is divided into a load transmission base for supporting the load transmitting member and a load sensor base for supporting the load sensor.

According to another embodiment of the invention, the height of the load sensor base is set smaller than that of the load transmission base.

Since the seat weighing system, according to embodiments of the invention, has a base divided into a load transmission base and a load sensor base, a load transmitting section and a load sensor section can be independently subassembled. This facilitates the assembly of the seat weighing system.

According to an embodiment of the invention, since the height of the load sensor base is set smaller than that of the load transmission base, the height of the entire seat weighing system including the base can be reduced even when a fastener protrudes downward from the bottom plate of the load sensor base.

According to another embodiment of the present invention, a seat weighing system comprises a transmitting section comprising a first base, and a sensor section comprising a second base, wherein the transmitting section is configured to be assembled external of and independent of the sensor section.

A seat weight sensing system comprises a load sensor, and a load transmitting member for transmitting the seat weight to the load sensor. The load sensor and the transmitting member are supported by separate and connected base members.

According to another embodiment of the invention, an occupant detection device comprises a load sensor; a load transmitting member for transmitting the seat weight to the load sensor. The load sensor and the load transmitting member are supported by separate and connected base members.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of an embodiment of a seat weighing system according to the present invention.

FIGS. 2(A), 2(B), and 2(C) show the seat weighing system of FIG. 1, in which FIG. 2(A) is a plan view thereof, FIG. 2(B) is a sectional view taken along line A-A of FIG. 2(A), and FIG. 2(C) is a right side view thereof.

FIGS. 3(A), 3(B) show part of the seat weighing system of FIG. 1, in which FIG. 3(A) is a perspective view of a load transmitting section and FIG. 3(B) is a perspective view of a load sensor section.

FIGS. 4(A), 4(B) show the load transmitting section and the load sensor section of FIGS. 3(A), 3(B), in exploded view, in which FIG. 4(A) is an exploded perspective view of the load transmitting section and FIG. 4(B) is an exploded perspective view of the load sensor section.

FIGS. 5(A), 5(B) partially show the front of a conventional seat weighing system, in which FIG. 5(A) is an exploded perspective view thereof and FIG. 5(B) is a front sectional view of a pin bracket.

FIGS. 6(A), 6(B), 6(C), 6(D) partially show the front of the conventional seat weighing system of FIGS. 5(A), 5(B), in which FIG. 6(A) is a plan view thereof, FIG. 6(B) is a sectional view taken along the length, FIG. 6(C) is a sectional view taken along line C-C of FIG. 6(B), and FIG. 6(D) is a sectional view taken along line D-D of FIG. 6(B).

FIG. 7 is a partial perspective view of a load sensor section of a conventional seat weighing system.

### DETAILED DESCRIPTION OF THE PREFERRED EMBODIMENTS

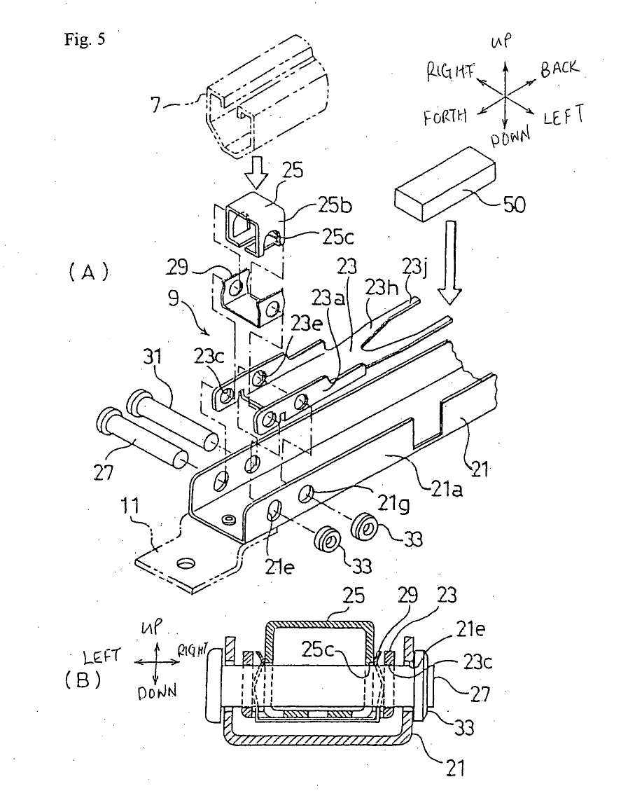

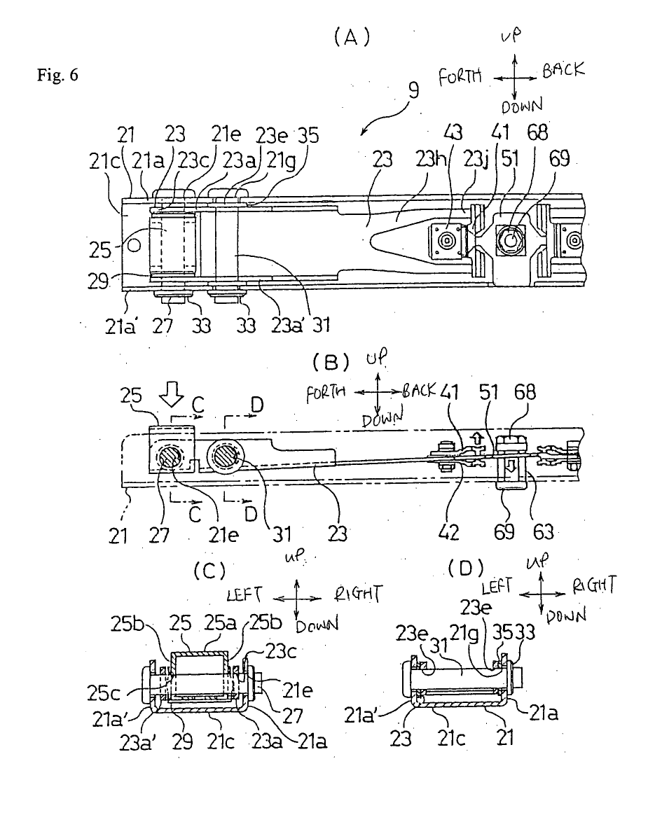

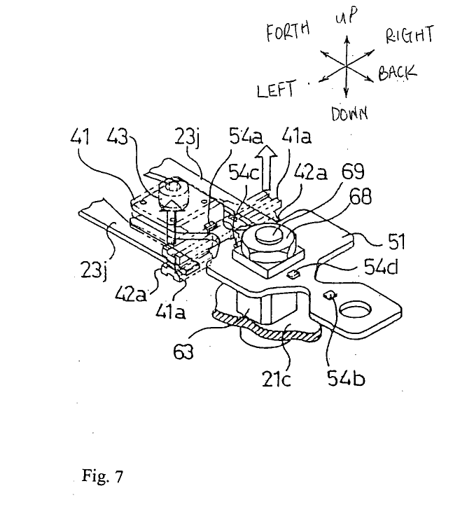

Hereinafter, embodiments of the present invention will be described with reference to the attached drawings. The same components as those of the seat weighing system disclosed in Japanese Unexamined Patent Application No. 2001-041813 of FIGS. 5(A) to 7 are given the same numerals and their description will be omitted

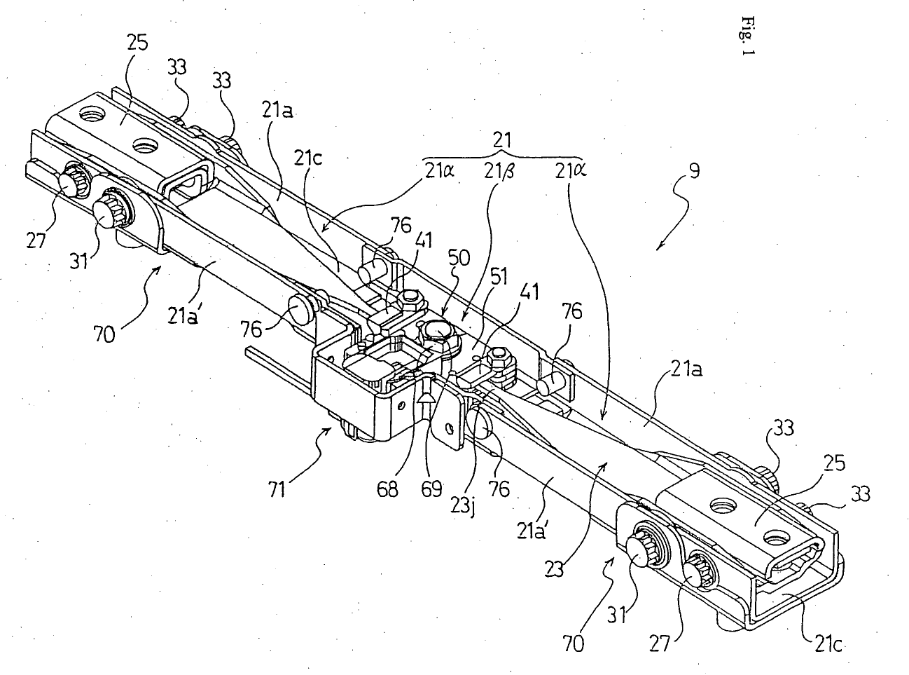

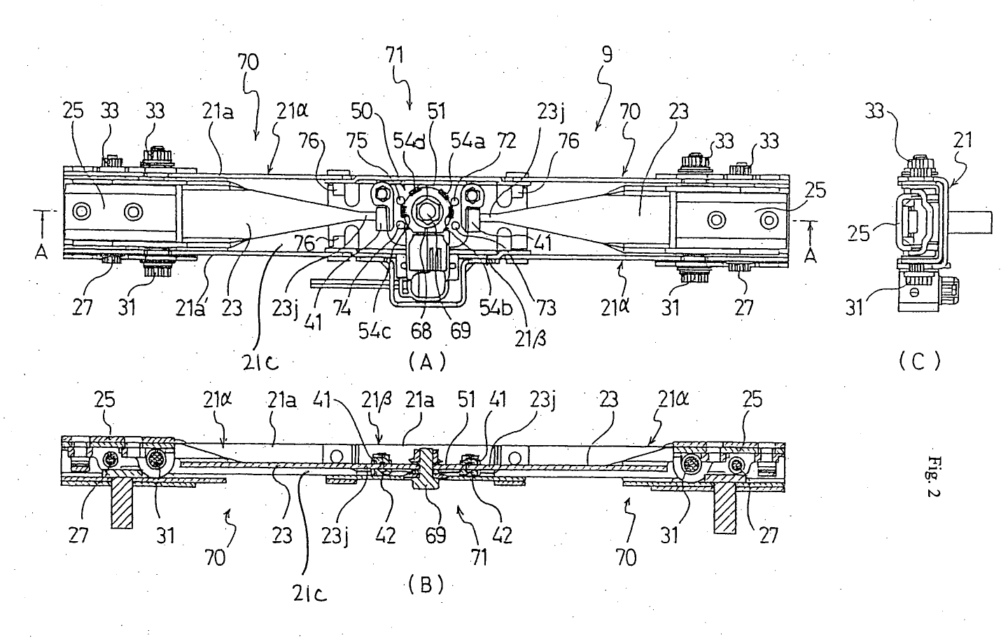

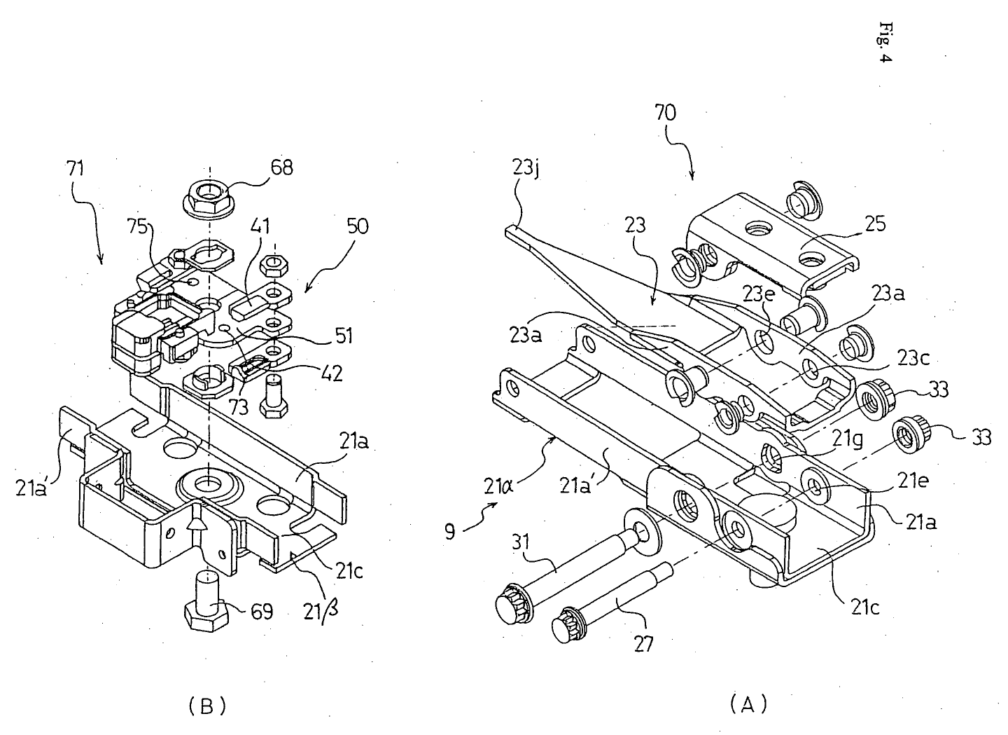

Referring to FIG. 1 and FIGS. 2(A), 2(B), and 2(C), the seat weighing system 9 of this embodiment may include front and rear load transmitting sections 70 (shown in FIG. 4(A)) and a load sensor section 71 (shown in FIG. 4(B)) disposed between the load transmitting sections 70, which can be separated from each other. Accordingly, the base 21 may be constructed of two load transmission bases 21α in the load transmitting sections 70 and a load sensor base 21β in the load sensor section 71. The load transmission bases 21α and the load sensor base 21β are of U-shape cross section. In this case, the two front and rear load transmission bases 21α have approximately the same size as that of the base 21 disclosed in Japanese Unexamined Patent Application No. 2001-041813, while the load sensor base 21β has a bottom with a shallower depth than the load transmission bases 21α. The height of the load sensor base 21β is set smaller than that of the two front and rear load transmission bases 21α.

Referring to FIG. 2(B), the front and rear ends of the bottom plate 21c of the load sensor base 21β are placed on the bottom plates 21c of the two front and rear load transmission bases 21α. The side plates 21a and 21a′ of the load transmission bases 21 a and the side plates 21a and 21a′ of the load sensor base 21β are joined together, with this state, with four joints 76 such as bolts to construct the entire base 21. As described above, the side plates 21a and 21a′ of the two load transmission bases 21α and the side plates 21a and 21a′ of the load sensor base 21β are set to have the same height when the entire base 21 is constructed.

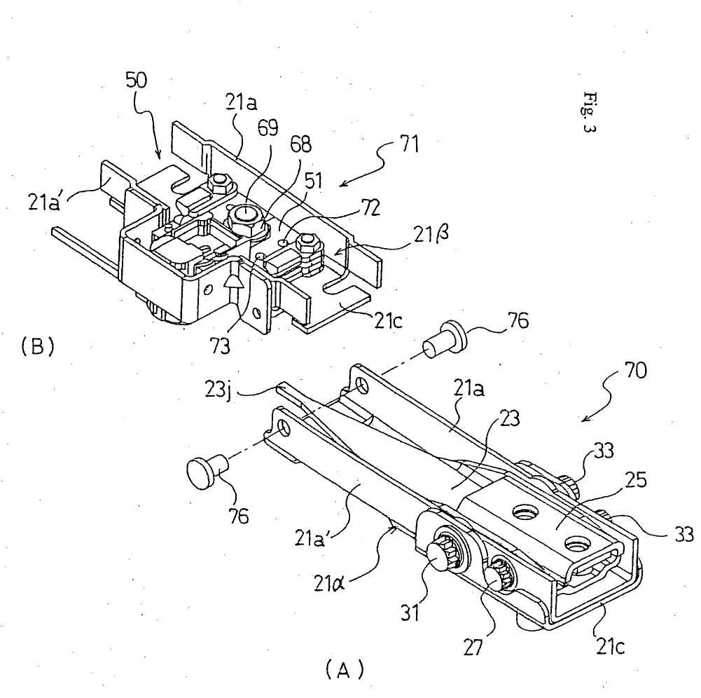

Referring to FIGS. 3(A) and 4(A), the load transmission bases 21α in the rear load transmitting section 70 includes therein the pin bracket 25 to which a seat weight is applied and the arm 23 to which the seat weight is transferred from the pin bracket 25. The arm 23 is made of an elastic material. The arm 23 is different from the arm 23 disclosed in Japanese Unexamined Patent Application No. 2001-041813, which is forked to have the two operating sections 23j, and has no crotch section but has one operating section 23j at the end. Referring to FIG. 1 and FIGS. 2(A) and (B), the operating sections 23j is mounted to the sensor plate 51 with upper and lower half arms 41 and 42 such that the seat weight is transmitted from the arm 23 through the half arms 41 and 42 to the sensor plate 51.

The other structure of the arm 23 may be the same as that of the arm 23 disclosed in Japanese Unexamined Patent Application No. 2001-041813 and is rotatably supported to the side plates 21a and 21a′ of the base 21 with the base pin 31. The bracket pin 27 passes through the side plates of the arm 23, so that the seat weight from the pin bracket 25 is transmitted through the bracket pin 27 to the arm 23.

The pin bracket 25 is rotatably supported by the base pin 31 such that the applied seat weight is transmitted to the bracket pin 27.

While the front load transmitting section 70 has much the same structure as that of the rear load transmitting section 70, it is arranged in the vertically symmetric position with respect to the rear load transmitting section 70.

Referring now to FIG. 2(A), the seat weighing system 9 includes a specified number (four in the drawing) of strain resistors 54a, 54b, 54c, and 54d disposed and bonded (mounted) on the sensor plate 51 in a concentric configuration with the sensor center (the center of the fastener 69). In other words, the four strain resistors 54a, 54b, 54c, and 54d are arranged at equal distances from the sensor center (the center of the fastener 69). The seat weighing system 9 may include a different, suitable number of strain resistors, other than four.

The sensor plate 51 in the vicinity of the bonding positions (mounting positions) of the two strain resistors 54b and 54c has a specified number (four in the drawing) of holes 72, 73, 74, and 75. Providing the holes 72, 73, 74, and 75 decreases the cross-sectional area of the sensor plate 51 in the vicinity of the positions at which the pairs of strain resistors 54a and 54b and the strain resistors 54c and 54d, making the sensor plate 51 deflect (be distorted) easily in this positions. This ensures load measurement with the strain resistors 54a, 54b, 54c, and 54d. The sensor plate may include more or less than four holes, as suitable.

Referring now to FIG. 2(B), the sensor plate 51 is fixed to the load sensor base 21β by passing the fastener 69 through the hole of the bottom plate 21c and the hole of the sensor plate 51 from under the bottom plate 21c of the load sensor base 21β and tightening it with the nut 68 (shown in FIG. 2(A)). At that time, since the bottom of the load sensor base 21β having the fastener 69 is shallower in depth than the load transmission bases 21α, the height of the entire seat weighing system 9 including the base 21 can be reduced even when the fastener 69 protrudes downward from the bottom plate 21c of the load sensor base 21β.

The other components of the seat weighing system 9 of this embodiment are the same as those of the seat weighing system disclosed in Japanese Unexamined Patent Application No. 2001-041813 shown in FIGS. 5(A) to 7.

Since the seat weighing system 9 of an embodiment may have the base 23 divided into the two load transmission bases 21α and the load sensor base 21β, the load transmitting sections 70 and the load sensor section 71 can be independently subassembled. This facilitates the assembly of the seat weighing system 9. Moreover, since the bottom of the load sensor base 21β of the load sensor section 71 is set shallower than that of the load transmission bases 21α, in other words, the height of the load sensor base 21β is set smaller than that of the load transmission bases 21α, the height of the entire seat weighing system 9 including the base 21 can be reduced even when the fastener 69 protrudes from the bottom plate 21c of the load sensor base 21β.

The seat weight transmitted to the arm 23 is transferred through one operating section 23j to the sensor plate 51. As described above, the arm 23 is not forked such that it has one operating section 23j, which reduces variations in load transmission. Thus, manufacturing accuracy of the arm 23 can be lower than that of the forked arm 23. Accordingly, the arm 23 can be manufactured easily at low cost.

Since the four strain resistors 54a, 54b, 54c, and 54d are arranged at equal distances from the sensor center (the center of the fastener 69), they are not nonuniformly affected by the heat transmitted through the fastener to the sensor plate due to sudden temperature changes, which prevents the bridge of the four strain resistors 54a, 54b, 54c, and 54d from getting out of balance. Thus, a weighing error due to the strain resistors can be reduced to allow more precise seat weight measurement.

Furthermore, since the sensor plate 51 has the four holes 72, 73, 74, and 75 in the vicinity of the positions at which the two strain resistors 54b and 54c are mounted (bonded), the cross-sectional area of the sensor plate 51 in the vicinity of the load-sensor mounting position can be decreased by providing the holes 72, 73, 74, and 75. Thus, the sensor plate 51 in the load-sensor mounting position can easily deflect (be distorted), allowing the point of deflection to be focused in the load-sensor mounting position to increase the sensitivity of the load sensor 50 and increasing the resistance to the distortion of the sensor plate. This ensures accurate load weighing by the load sensor.

According to the above-described embodiment, although the arm 23 that transmits a load to the load sensor 50 includes only one operating section 23j, the invention is not limited to that and may also be applied to the seat weighing system 9 including the forked arm 23 having the two operating sections 23j.

The seat weighing system according to the present invention can be appropriately applied to a seat weighing system mounted to a vehicle seat whose height is limited, for weighing the seat including a seated occupant.

Japan Patent Application 2003-184967, filed Jun. 27, 2003 including the specification, drawings, claims and abstract, is incorporated herein by reference in its entirety. Japan Patent Application 2004-028889, filed Feb. 05, 2004 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat weighing system comprising:
a load sensor for weighing a seat including an occupant seated in a vehicle seat;
a load transmitting member for transmitting the seat weight to the load sensor; and
a base for supporting the load sensor and the load transmitting member,
wherein the base is divided into a load transmission base for supporting the load transmitting member and a load sensor base for supporting the load sensor.

2. A seat weighing system according to claim 1, wherein the height of the load sensor base is set smaller than that of the load transmission base.

3. A seat weighing system comprising:
a transmitting section comprising a first base, and
a sensor section comprising a second base,
wherein the transmitting section is configured to be assembled external of and independent of the sensor section.

4. The seat weighing system according to claim 3, wherein the height of the second base is configured to be smaller than the height of the first base.

5. A seat weight sensing system comprising:
a load sensor;
a load transmitting member for transmitting the seat weight to the load sensor;
wherein the load sensor and the transmitting member are supported by separate and connected base members.

6. The seat weight system according to claim 5, wherein the base member supporting the load sensor is positioned lower than the base member supporting the load transmitting member.

7. The seat weight sensor according to claim 6, further comprising a second load transmitting member.

8. The seat weight sensor according to claim 7, wherein the second load transmitting member is positioned on the opposite side of the load sensor as the first transmitting member.

9. The seat weight sensor according to claim 7, wherein the second load transmitting member is supported by a second base member.

10. The seat weight sensor according to claim 9, wherein each base member comprises side plates; wherein a side plate of the first load transmitting base member adjoins a side plate of the load sensor base member; and wherein a side plate of the second load transmitting base member adjoins a side plate of the load sensor base member.

11. The seat weight sensor according to claim 10, wherein the side plates of the load sensor base member and the first and second load transmitting base members are configured to have approximately equal height when the base members are connected.

12. An occupant detection device system comprising:
a load sensor;
a load transmitting member for transmitting the seat weight to the load sensor;
wherein the load sensor and the load transmitting member are supported by separate and connected base members.

13. The occupant detection device according to claim 12, wherein the base member supporting the load sensor is positioned lower than the base member supporting the load transmitting member.

14. The occupant detection device according to claim 13, wherein each base member comprises side plates; and
wherein the side plates of the load sensor base member and the load transmitting base member are configured to have approximately equal height when the base members are connected.
